(19) United States
(12) Patent Application Publication
(10) Pub. No.: US 2018/0141726 A1
(43) Pub. Date: May 24, 2018

(54) DISPENSER PACKAGE WITH FLIP-UP OR FLIP-OUT LID AND METHOD OF MAKING THE SAME

(71) Applicant: MCCORMICK & COMPANY, INCORPORATED, Sparks, MD (US)

(72) Inventors: Erik HOLM, Mars, PA (US); Thomas Koll Porter GIESKE, Lutherville, MD (US); Tracie L.C. WILSON, Westminster, MD (US); Troy A. HILL, Reading, PA (US)

(73) Assignee: MCCORMICK & COMPANY, INCORPORATED, Sparks, MD (US)

(21) Appl. No.: 15/819,089

(22) Filed: Nov. 21, 2017

Related U.S. Application Data
(60) Provisional application No. 62/425,266, filed on Nov. 22, 2016.

(51) Int. Cl. B65D 47/08; B65D 83/06; B65D 1/02; B65D 23/00; A47J 47/04; A47J 47/01

(52) U.S. Cl. CPC B65D 47/0838; B65D 83/06; B65D 1/0207; B65D 2101/0038; A47J 47/04; A47J 47/01; B65D 23/003

(57) ABSTRACT

Dispenser package comprising a planar backing, a dispenser body coupled to the backing and a flip-up or flip-out cover movable between a closed position and an open position.

### CROSS-REFERENCE TO RELATED APPLICATIONS

The instant application is a US non-provisional application claiming the benefit of U.S. provisional application No. 62/425,266 filed on Nov. 22, 2016, the disclosure of which is hereby expressly incorporated by reference thereto in its entirety.

### BACKGROUND OF THE INVENTION

### 1. Field of the Invention

This invention relates generally to package dispensers or dispenser packaging and especially for dry food or granulated product such as, e.g., spice, salt or pepper containers, and well as a method of making and using the same.

### 2. Discussion of Background Information

Known packaging dispensers are available in small size but are generally not closeable. These include flexible film sachets or non-recloseable rigid devices such as Recipe Inspirations. See, e.g., U.S. Design Pat. No. D628,090 issued on Nov. 30, 2010, D642,482 issued on Aug. 2, 2011, and D642,483 issued on Aug. 2, 2011.

However, existing or known dry food packaging dispensers lack one or more features utilized in the packaging dispenser disclosed herein.

### SUMMARY OF THE INVENTION

According to one non-limiting embodiment of the invention, there is provided a dispenser package comprising a planar backing, a dispenser body secured to the backing and a flip-up cover movable between a covering position and an open position.

In embodiments, the backing is non-transparent.

In embodiments, the backing is rectangular.

In embodiments, the backing comprises an opening arranged adjacent at an upper end.

In embodiments, the container body is transparent or translucent.

In embodiments, the container body is semi-cylindrical.

In embodiments, the container body comprises a semi-cylindrical main section.

In embodiments, the container body comprises a dispensing opening arranged adjacent at an upper end.

In embodiments, the dispenser opening arranged on a generally planar surface.

In embodiments, the flip-up cover is pivotally mounted.

In embodiments, the flip-up cover is connected to the dispenser body via a living hinge.

In embodiments, the flip-up cover a finger grippable portion and a covering portion, said covering portion having a three-dimensional shape that mimics a three-dimensional shape of an upper portion of the container body.

In embodiments, the dispenser package is a food or spice dispenser package.

In embodiments, the flip-up cover comprises a retaining mechanism that releasably engages with a retaining mechanism of the dispenser body.

The invention also provides for a food product dispenser package comprising a rectangular or planar backing, a dispenser body secured to the backing, a dispensing opening and a pivotally mounted flip-up cover movable between a position overlying the dispensing opening and an open position allowing spice to be dispensed from the dispensing opening.

The invention also provides for a food particulate dispenser package comprising a rectangular planar backing, a dispenser body secured to the backing, a dispensing opening arranged at an upper area of the dispenser body and a pivotally mounted flip-up cover movable between a releasably locked or retained position overlying the dispensing opening and an open position allowing a food particulate to be dispensed from the dispensing opening.

The invention also provides for a spice dispenser package comprising a rectangular planar backing, a transparent synthetic resin dispenser body secured to the backing, a dispensing opening arranged at an upper area of the dispenser body and a transparent synthetic resin pivotally mounted flip-up cover movable between a releasably locked or retained position overlying the dispensing opening and an open position allowing spice to be dispensed from the dispensing opening.

The invention also provides for a method of making the package of anyone of the types described above, wherein the method comprises forming a dispenser body and attaching the dispenser body to a backing.

The invention also provides for a method of making the package of anyone of the types described above, wherein the method comprises forming a dispenser body with an integral flip-up cover and attaching the dispenser body to a backing.

Other exemplary embodiments and advantages of the present invention may be ascertained by reviewing the present disclosure and the accompanying drawing.

### BRIEF DESCRIPTION OF THE DRAWINGS

The present invention is further described in the detailed description which follows, in reference to the noted plurality of drawings by way of non-limiting examples of exemplary embodiments of the present invention, in which like reference numerals represent similar parts throughout the several views of the drawings, and wherein:

FIG. 1 shows a side perspective view of a packaging dispenser in accordance with the invention and with the flip-up lid being shown in a closed position and with the packaging dispenser being in an empty or unfilled state;

FIG. 2 shows a front view of the packaging dispenser shown in FIG. 1;

FIG. 3 shows a rear view of the packaging dispenser shown in FIG. 1;

FIG. 4 shows a right-side view of the packaging dispenser shown in FIG. 1;

FIG. 5 shows a left-side view of the packaging dispenser shown in FIG. 1;

FIG. 6 shows a top view of the packaging dispenser shown in FIG. 1;

FIG. 7 shows a bottom view of the packaging dispenser shown in FIG. 1;

FIG. 8 shows a front view of the packaging dispenser shown in FIG. 1 but with the flip-up lid in a fully open position;

FIG. 9 shows a right-side view of the packaging dispenser shown in FIG. 8;

FIG. 10 shows a side perspective view of a packaging dispenser in accordance with another embodiment of the invention and with the flip-up lid being shown in a closed position and with the packaging dispenser being in an empty or unfilled state;

FIG. 11 shows a front view of the packaging dispenser shown in FIG. 10;

FIG. 12 shows a rear view of the packaging dispenser shown in FIG. 10;

FIG. 13 shows a right-side view of the packaging dispenser shown in FIG. 10;

FIG. 14 shows a left-side view of the packaging dispenser shown in FIG. 10;

FIG. 15 shows a top view of the packaging dispenser shown in FIG. 10;

FIG. 16 shows a bottom view of the packaging dispenser shown in FIG. 10;

FIG. 17 shows a front view of the packaging dispenser shown in FIG. 10 but with the flip-up lid in a fully open position;

FIG. 18 shows a right-side view of the packaging dispenser shown in FIG. 17;

FIG. 19 shows the dispenser of FIG. 1 with the flip-up lid removed to illustrate possible locations for a dispenser opening peel-away tamper-resistant closure as well as a packaging label;

FIG. 20 shows a right-side view of the packaging dispenser similar to that shown in FIG. 1 but containing a dispensable substance or container contents and illustrates an opening of the flip-up lid or cover;

FIG. 21 shows a front view of the container of FIG. 20 but with the flip-up lid or cover in the closed position and with width and height dimensions;

FIG. 22 shows a cross-section view of FIG. 21 and shows a fill level of the dispensable substance or container contents;

FIG. 23 shows a perspective view of the packaging body used in the packaging dispenser shown in FIG. 1 and with the backing panel removed or not yet attached. The flip-up lid is in an open position;

FIG. 24 shows a perspective view of the packaging body of FIG. 23 with the flip-up lid is in a closed position;

FIG. 25 shows a top view of the packaging body of FIG. 24 and having a thickness dimension;

FIG. 26 shows a front view of the packaging body of FIG. 24 and with width and height dimensions;

FIG. 27 shows a cross-section view of FIG. 26;

FIG. 28 shows a perspective view of another embodiment of a packaging dispenser and containing a dispensable substance or container contents and illustrates a closed flip-up lid or cover. Like previous embodiments, this embodiment can utilize a sheet or planar (e.g., paper) backing;

FIG. 29 shows a front view of the container of FIG. 28 and with width and height dimensions;

FIG. 30 shows a top view of the container of FIG. 28 and with a thickness dimension;

FIG. 31 shows a cross-section view of FIG. 29 and shows a fill level of the dispensable substance or container contents;

FIG. 32 shows an enlarged partial view of a portion of FIG. 31 and illustrates how a dome or dimple of the flip-up lid can extend into and closes-off the dispensing opening when in the closed position;

FIG. 33 shows a left side view of FIG. 28;

FIG. 34 shows a right side view of FIG. 28 with the flip-up lid in the opened position;

FIG. 35 shows a perspective view of the packaging body used in the packaging dispenser shown in FIG. 28 and with the backing panel removed or not yet attached. The flip-up lid is in an open position;

FIG. 36 shows a front view of the body of FIG. 35 and with width and height dimensions;

FIG. 37 shows a cross-section view of FIG. 36 and with a thickness dimension;

FIG. 38 shows a left side view of FIG. 36;

FIG. 39 shows a bottom view of FIG. 36;

FIG. 40 shows a perspective view of another embodiment of a packaging dispenser and containing a dispensable substance or container contents and illustrates a closed flip-up lid or cover. Unlike previous embodiments, this embodiment does not utilize a sheet or planar (e.g., paper) backing and instead utilizes an integrally formed and/or foldable backing and also includes a foot that functions to support the package in a slightly tilted upright position;

FIG. 41 shows a left side view of FIG. 40;

FIG. 42 shows a right-side view of FIG. 40 and in an upright tilt-angled position;

FIG. 43 shows a top view of FIG. 40;

FIG. 44 shows a front view of FIG. 40 and with width and height dimensions;

FIG. 45 shows a cross-section view of FIG. 43 and shows a fill level of the dispensable substance or container contents;

FIG. 46 shows an enlarged partial view of a portion of FIG. 45 and illustrates how a dome or dimple of the flip-up lid can extend into and closes-off the dispensing opening when in the closed position;

FIG. 47 shows a right side view of FIG. 40 and illustrates how the flip-up can move to the open position;

FIG. 48 shows a perspective view of the embodiment of FIG. 40 with the flip-up lid in the opened position and with the backing member in an open and folded-out position;

FIG. 49 shows a front view of FIG. 48 and with width and height dimensions;

FIG. 50 shows a cross-section view of FIG. 49 and with thickness dimensions;

FIG. 51 shows a left side view of FIG. 49 and with a thickness dimension;

FIG. 52 shows a bottom view of FIG. 51;

FIG. 53 shows how the backing of an embodiment of the type shown in FIG. 40 can be folded to the closed position;

FIG. 54 shows how the flip-up lid of an embodiment of the type shown in FIG. 40 can be folded to the closed position;

FIG. 55 shows a perspective view of another embodiment of a packaging dispenser that can contain a dispensable substance or container contents and illustrates the same in a folded-out position. Unlike previous embodiments, this embodiment does not utilize a front facing flip-up cover and instead utilizes a back facing flip-out lid or cover that is integrally formed and/or foldably attached to a fold-out backing and also includes a foot that functions to support the package in a slightly tilted upright position;

FIG. 56 shows a front view of FIG. 55 and with width and height dimensions;

FIG. 57 shows a right side view of FIG. 55 and with thickness dimensions;

FIG. 58 shows a bottom view of FIG. 55;

FIG. 59 shows an enlarged view of a portion of FIG. 58;

FIG. 60 shows a perspective view of the embodiment of FIG. 55 with the backing and flip-out lid in the closed position;

FIG. 61 shows a front view of FIG. 60;

FIG. 62 shows a right-side view of FIG. 60 and in an upright tilt-angled position;

FIG. 63 shows a partial cross-section view of FIG. 62;

FIG. 64 shows a top view of FIG. 60;

FIG. 65 shows an enlarged view of a portion of FIG. 54;

FIG. 66 shows a rear-side perspective view of the embodiment of FIG. 60 but with the flip-our back facing lid in an open position. In this position, the packaging container can dispense the dispensable substance stored inside; and

FIG. 67 shows a cross-section view of FIG. 66 and shows a fill level of the dispensable substance stored inside.

### DETAILED DESCRIPTION OF THE INVENTION

The present invention is further described in the detailed description which follows, in reference to exemplary embodiments.

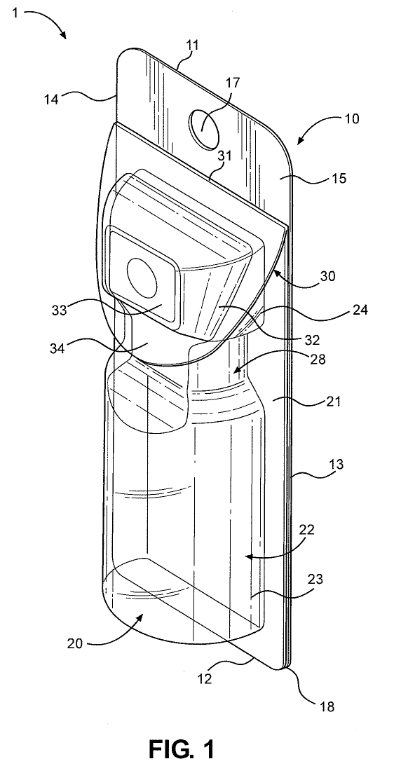

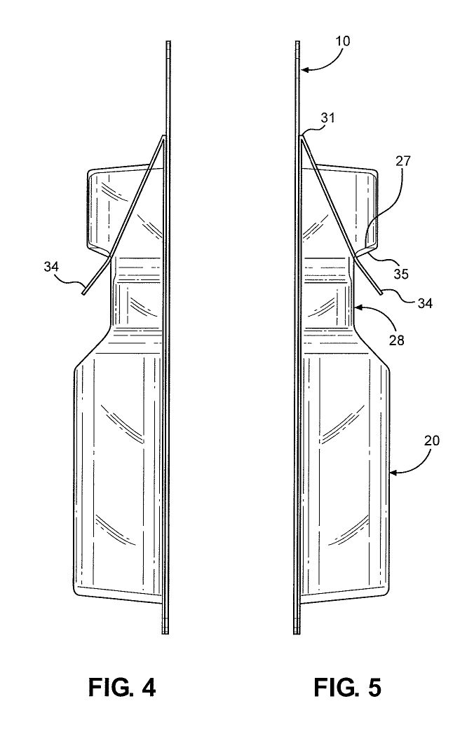

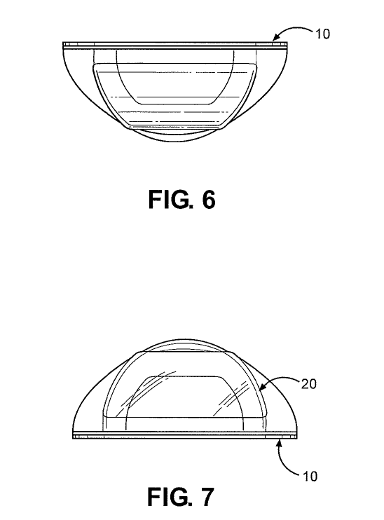

FIGS. 1-9 show a first non-limiting embodiment of a packaging dispenser 1. In embodiments, the dispenser 1 is sized and configured to contain a dispensable product such as a granulated or powder substance. In embodiments, the dispensable substance is a food product such as a spice or seasoning. In embodiments, the package 1 is transparent or translucent so that a user or consumer can readily determine both the nature of the substance contained therein and approximately how much of the substance remains therein, e.g., whether the package 1 is nearly full, nearly empty, etc. For example, if the dispenser 1 is a cumin spice container and has a transparent front side, a user can readily determine both the approximate amount contained and that it is likely ground cumin—with its distinctive yellow/brown and fine powder appearance.

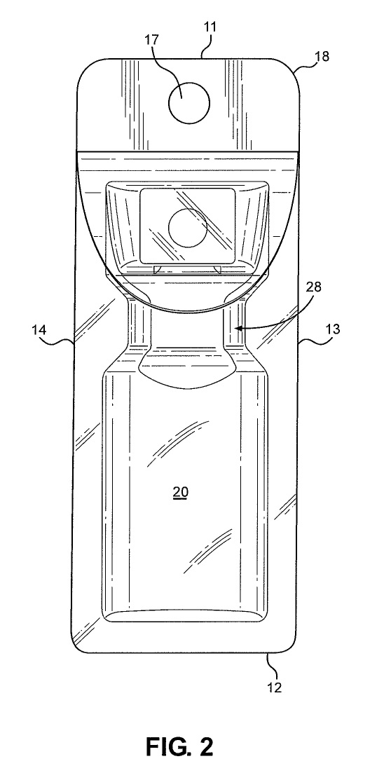

FIGS. 1 and 2 show how the packaging dispenser 1 has a generally planar backing 10 that can be generally rectangular in shape and a container portion 20 that is semi-circular in cross-section. Another main component of the package 1 is the closeable lid 30, as will be described later on.

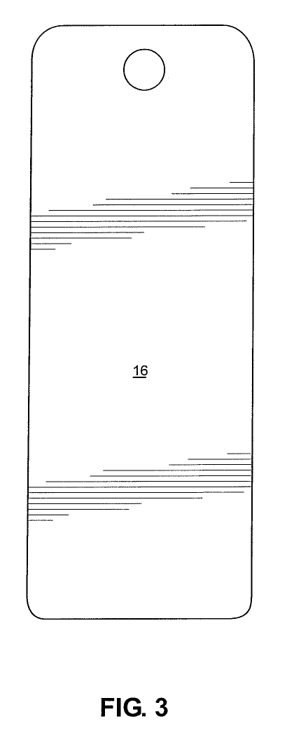

The backing 10 has an upper edge 11 and a lower edge 12 of similar length, as well as a right side edge 13 and a left side edge 14 which are of greater length than the upper and lower edges 11 and 12. The backing 10 also has a front side 15 and a back side 16 (see FIG. 3). In addition, the backing 10 includes an opening 17 which can advantageously be used to support the package 1 on a handing hook (not shown). The backing 10 can be made of paper, cardboard or synthetic resin, as well as a laminate of made of two or more layers of these. For example, the backing 10 may be made of paper that has a layer or coating of synthetic resin on at least the front side 15.

The container portion 20 resembles a spice container that has been cut in half along an up and down (vertical) direction. To secure the container portion 20 to the front side 15 of the backing 10, a flange portion 21 of the container 20 extends around the container 20 and has an outer peripheral edge that may generally correspond to that of the edges 12-14. The flange 21 can be secured to the backing 10 in a number of ways such as via adhesive bonding or ultrasonic welding. Preferably, the flange 21 is integrally formed with the container portion 20. As should be apparent, the backing 10 will form the back side the dispenser while the container portion 20 forms the front side thereof. The result is a half-container arrangement that has the appearance from the front of a full container. While this may seem disadvantageous, because this arrangement allows the package 1 to be more easily and conveniently stored such as by hanging the same (compared with full-side containers), it can be a welcome and advantageous tradeoff. In addition, whereas full-size containers can tip over and roll off of a surface such as a table, this is essentially prevented with the arrangement according to the invention.

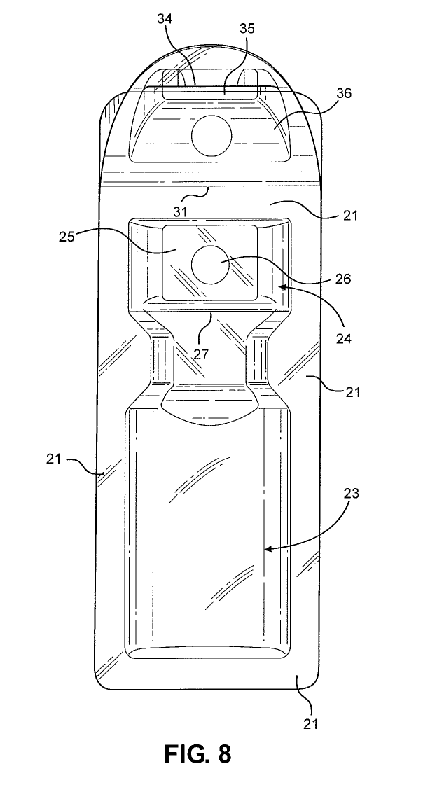

The container portion 20 has a main body 22 which is made up of a lower portion 23 of larger volume and an upper portion 24 holding less volume. A narrower section or neck region 28 is located between the portions 23 and 24. As is shown in FIG. 8, the upper portion 24 may include a generally planar and rectangular dispensing end 25 that has a dispensing opening 26 through which is dispensed the product or substance contained in the dispenser 1. A retaining flange 27 is located beneath the end 25. Engagement and disengagement between the retaining flange or shoulder 27 and the closeable lid 30 can advantageously generate a snap-connection whose sound would be heard or felt by the user—providing an audible and/or tactile indication of opening and closing.

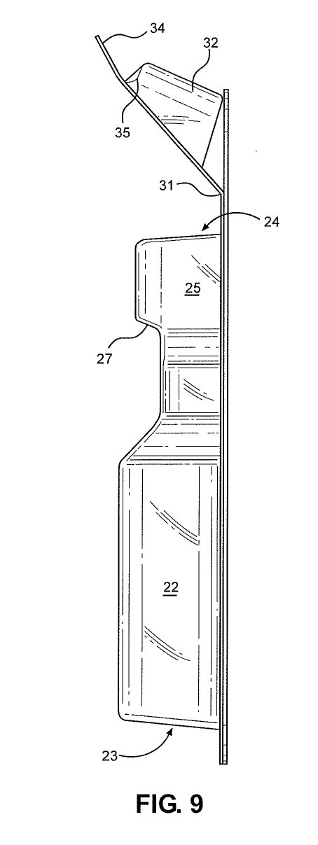

As should be apparent from FIGS. 1, 2, 4, 8 and 9, a closeable lid 30 is utilized which can pivot about a living hinge 31 between an open position shows in FIGS. 8 and 9 and a closed position shown in FIGS. 1, 2 and 4. The lid 30 is retained in the closed position by engagement between a retaining projection 35 and the retaining shoulder 27. In order to more easily position the lid 30 in these positions, the lid 30 includes a grip or lift tab 34. The lid 30 has body 32 whose shape and internal space 36 closely conforms or matches that of the upper portion 24. As a result, in the closed position, a comparable planar and rectangular surface of the lid 30 will overlie and generally abut the surface 25. In addition, because the comparable surface of the lid 30 lacks any opening, in the closed position, the comparable surface of the lid 30 will block or close off the opening 26 and will both prevent the product from being dispensed and aid in preventing contamination of the dispensable product stored in the package 1.

In order that the dispenser 1 is made at lower cost, it is desirable that the body 20 and the lid 30 be formed as a one-piece member made of a transparent synthetic resin material. To allow these to more relative to each other, the living hinge 31 can be formed by creating a thinned area in the manner of a fold line. The member can then be filled with the dispensable product and joined to the backing 10 via the connection between the front side 15 and the flange 21.

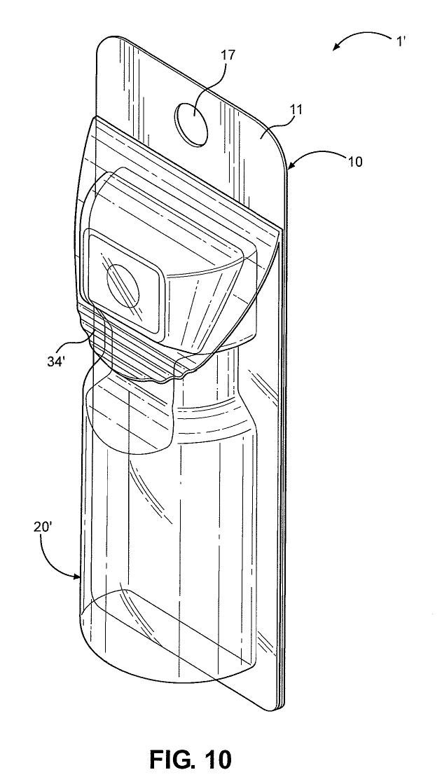

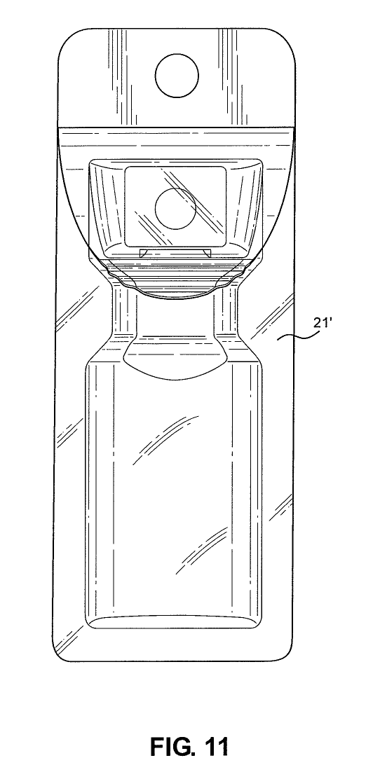

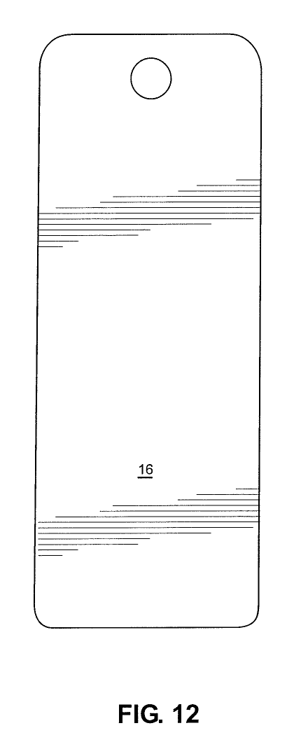

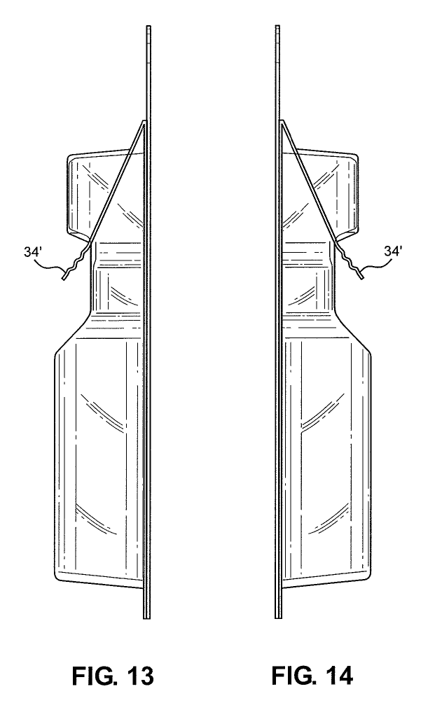

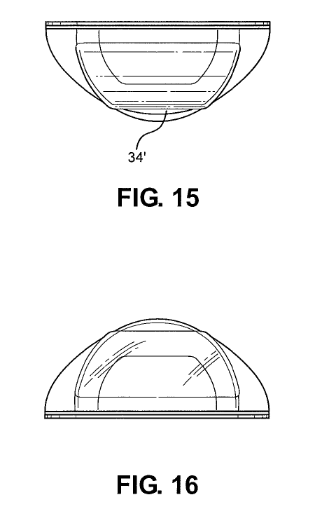

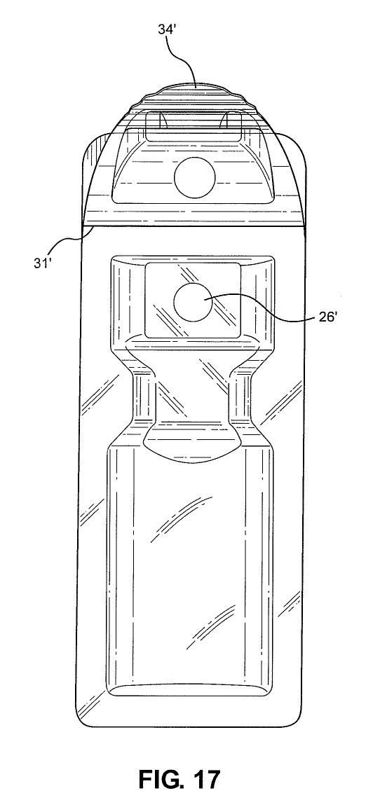

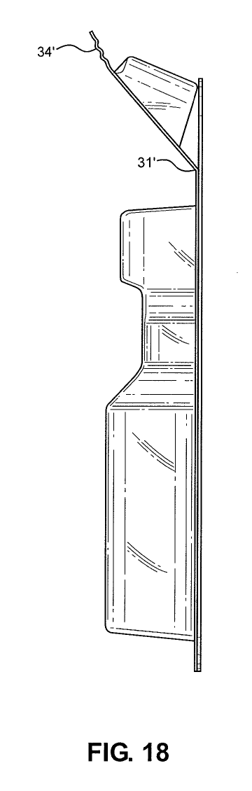

FIGS. 10-18 show a second non-limiting embodiment of a packaging dispenser 1′. This embodiment is similar to that of FIG. 1 except that the lift-tab 34′ includes a corrugated profile. The backing 10 can be essentially the same as that of the first embodiment. The features of the body 20′ and lid 30′ are otherwise similar except for the corrugated lift-tap 34′. Thus the dispenser 1′ can include, among other things, a transparent body 20′, a securing flange 21′, a dispensing opening 26′ and a living hinge 31′.

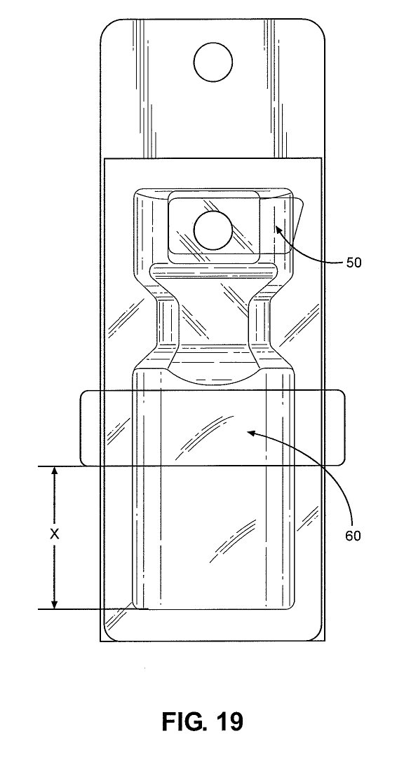

FIG. 19 shows the dispenser of either FIG. 1 or FIG. 10 with the flip-up lid removed to illustrate possible locations for a dispenser opening peel-away tamper-resistant closure 50 as well as a packaging label 60. Label 50 has a portion that overlies and closes off the dispensing opening while being adhesively attached to the planar surface of the section 25. Label 50 also has a gripable portion that extends beyond the section 25. In use, a user would be able to see label 50 with the lid 30 in the closed position—owing the transparent nature of the lid 30. At the time of first use, the user would open the closeable lid 30 and then peel-off label 50 to expose the opening 26. Label 50 can then be discarded—with the user relying upon the closeable lid 30 to close off the dispenser opening 26 when the dispenser 1 is stored. In this way, label 50 functions as an initial purchase or use tamper-resistant or safety closure. Label 50 can generally track the outer curved shape of the body 20 and is designed to be non-removable. In embodiments, it has the function of identifying the substance or product stored inside the dispenser 1. The location of the label 60 can be at dimension X.

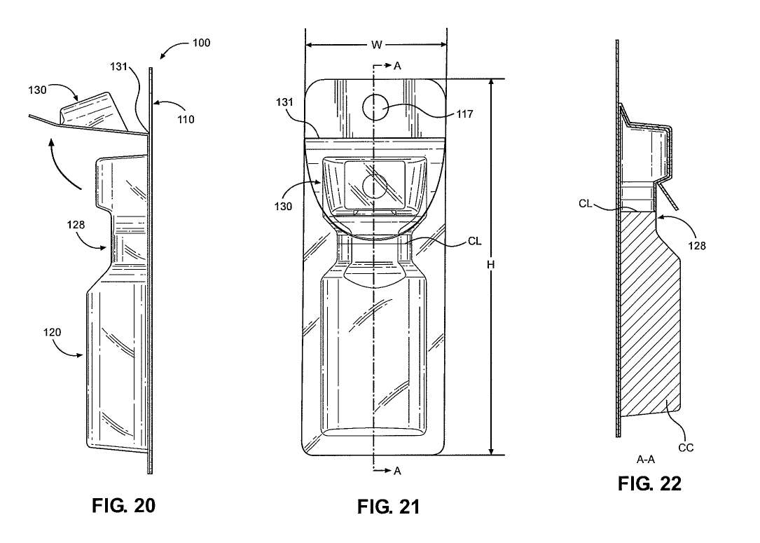

FIGS. 20-27 show a packaging dispenser 100 that is similar to that shown in FIG. 1 but which is shown contain an amount of dispensable substance (container contents) CC and illustrates how the flip-up lid or cover 130 can move or pivot to the open position about the living hinge 131. As with the embodiment of FIG. 1, this embodiment can use a planar backing 110 such as a paper backing. An exemplary fill level CL for the contents CC is shown in FIG. 22, which level CL can be located about the vertical midway of the neck region 128. As with the embodiment shown in FIG. 1, the package 100 utilizes a semi-cylindrical (or semi-circular in cross-section) body 120 whose surrounding flange is attached to a generally planar backing 110 and similarly uses a flip-up lid 130 that can be locked or releasably retained in the closed position as well as an opening 117 for hanging the package 100. The flip-up lid 130, when in the closed position, closes off the dispenser opening in same manner as that of the embodiment of FIG. 1. In non-limiting embodiments, the volume of the contents CC is about 1.6 cubic inches and the exemplary values for the width W and height H are respectively about 1.9 inches and about 4.8 inches.

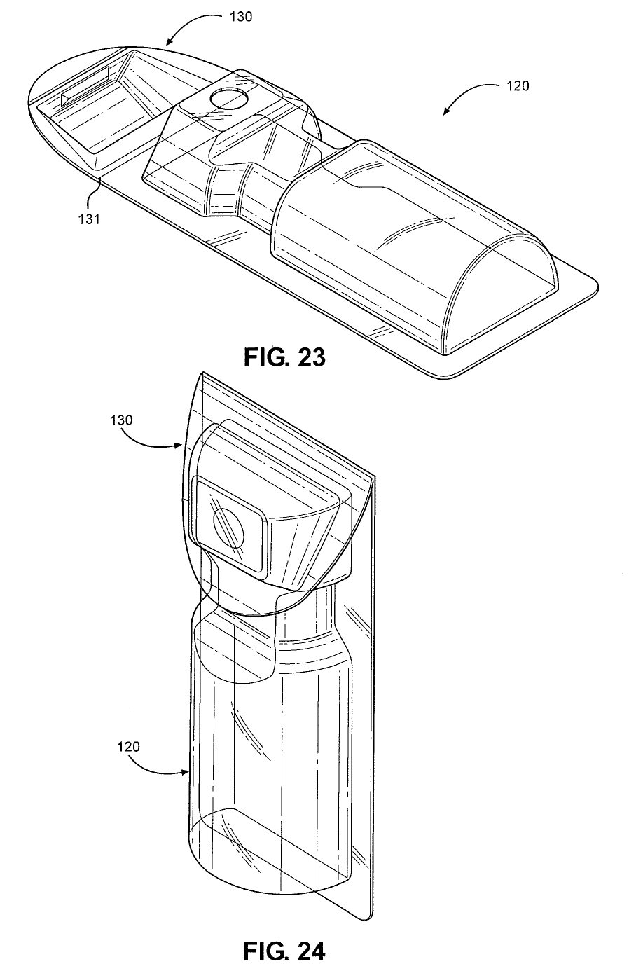

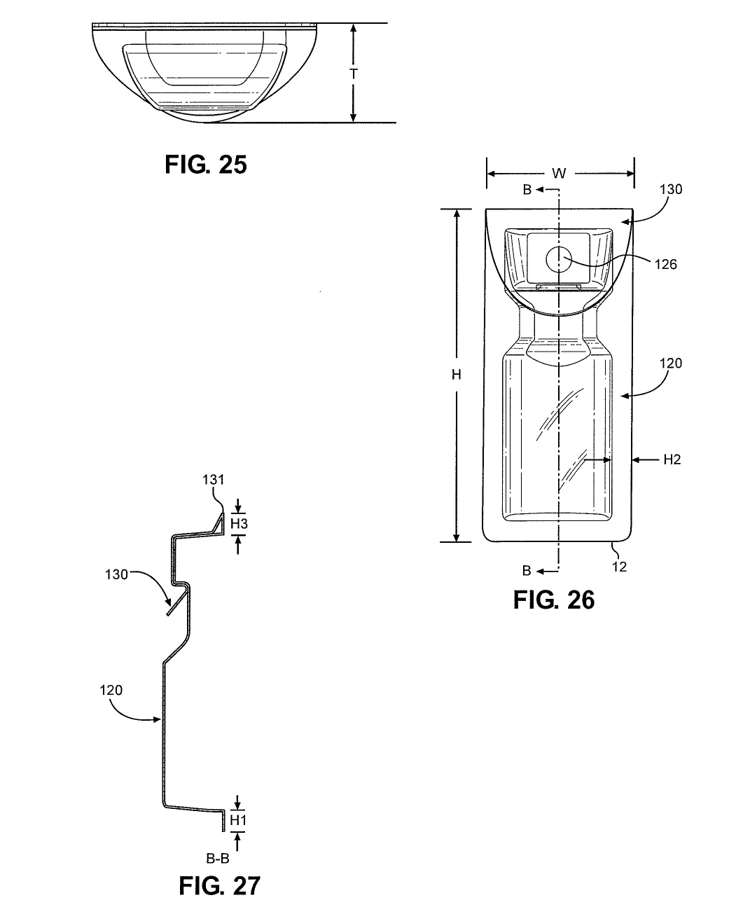

FIGS. 23-27 show a packaging dispenser body and lid member 120/130 without the backing 110 attached. As should be apparent, the body 120/130 can be a one-piece integrally formed member that is shaped from a thin sheet of transparent synthetic resin material. In non-limiting embodiments, the thickness is substantially uniform with the possible exception of the living hinge 131. The values for the dimensions shown in FIGS. 25 and 26 are, in non-limiting examples, as follows: W is about 1.9 inches, H is about 4 inches, the diameter of the dispensing opening 126 is about 0.33 inches, and the thickness T is about 0.77 inches. The surrounding flange, which secures the body 120 to the backing 110, can have the following values: H1 is about 0.25 inches, H2 is about 0.25 inches, and H3 is about 0.25 inches. In addition, a radius of the semi-cylindrical main section of the body 120 is about 0.66 inches in non-limiting embodiments.

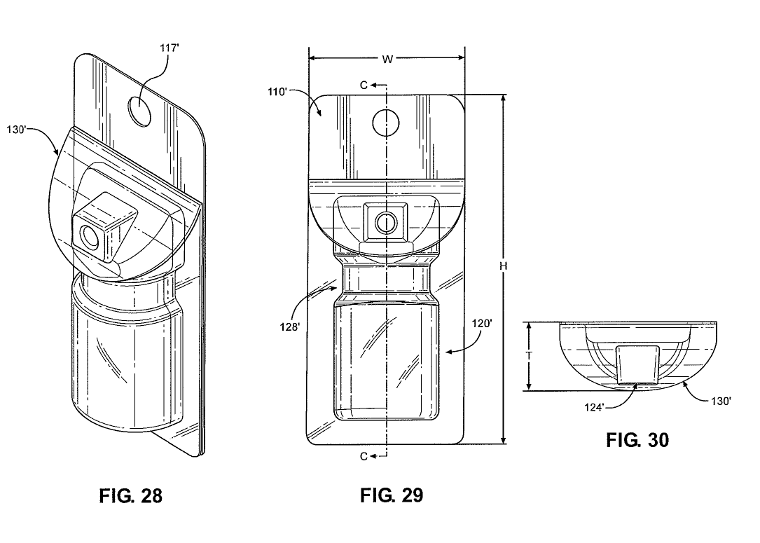

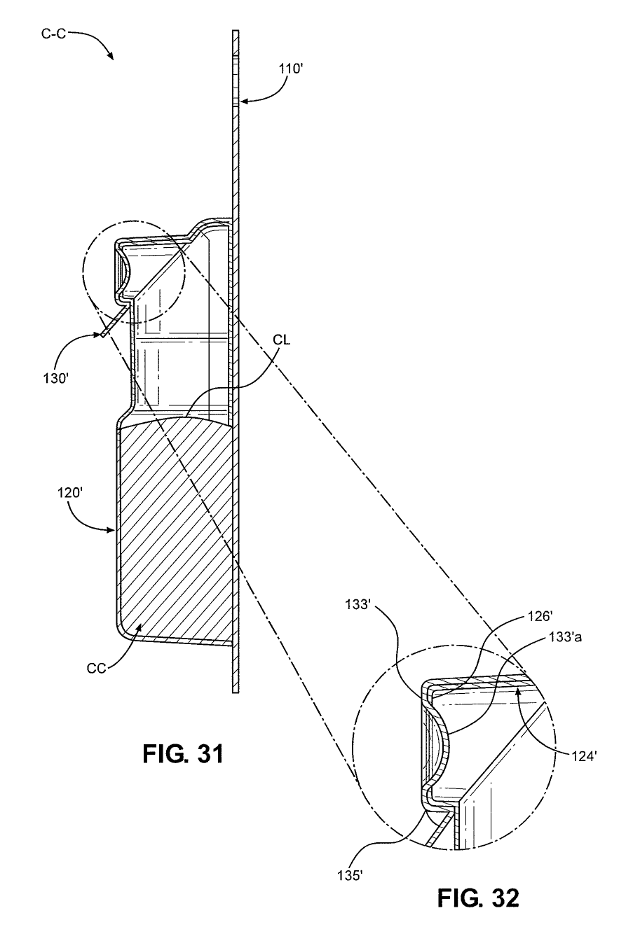

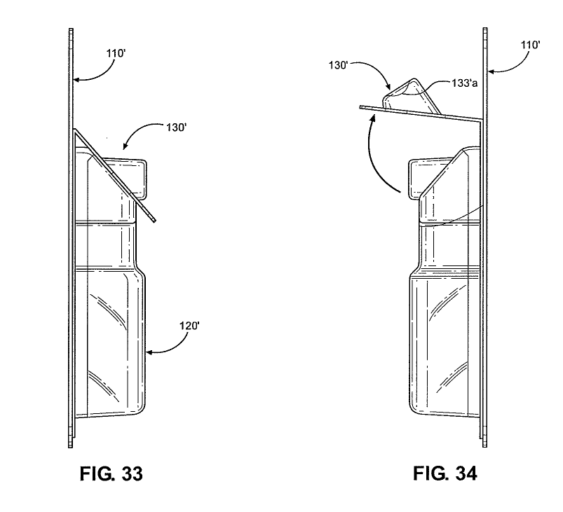

FIGS. 28-39 show a packaging dispenser 100′ that is similar to that shown in FIG. 20 and which is shown contain an amount of dispensable substance (container contents) CC and illustrates how the flip-up lid or cover 130′ can move or pivot to the open position about the living hinge 131′. As with the embodiment of FIG. 20, this embodiment can use a planar backing 110′ such as a paper backing. An exemplary fill level CL for the contents CC is shown in FIG. 31, which level CL can be located about the lower end of the neck region 128′. However, this embodiment mainly differs from that of FIG. 20 by its use of a smaller-sized and more rectangular shaped dispensing head portion 124′. As with the embodiment shown in FIG. 20, the package 100′ utilizes a semi-cylindrical (or semi-circular in cross-section) body 120′ whose surrounding flange is attached to a generally planar backing 110′ and similarly uses a flip-up lid 130′ that can be locked or releasably retained in the closed position by engagement between a retaining recess 135′ and a retaining projection located at a lower end of the section 124′. An opening 117′ for hanging the package 100′ is also utilized. The flip-up lid 130′, when in the closed position, closes off the dispenser opening. However, whereas the embodiment of FIGS. 1 and 20 close off the dispensing opening by the abutting positioning of a planar section of the flip-up lid over the dispensing opening, the embodiment of FIG. 28 employs a dome-shaped dimple 133′a (see FIG. 32) that extends into the dispensing opening 126′ and whose circular region 133′ sealing engages with the circular inner edge of the dispensing opening 126′ (see FIG. 32). The dispensing opening 126′ is arranged on a smaller rectangular planar section 125′. In non-limiting embodiments, the volume of the contents CC is about 1.6 cubic inches and the exemplary values for the width W and height H are respectively about 2.3 inches and about 5.0 inches. The value for thickness T is about 0.99 inches.

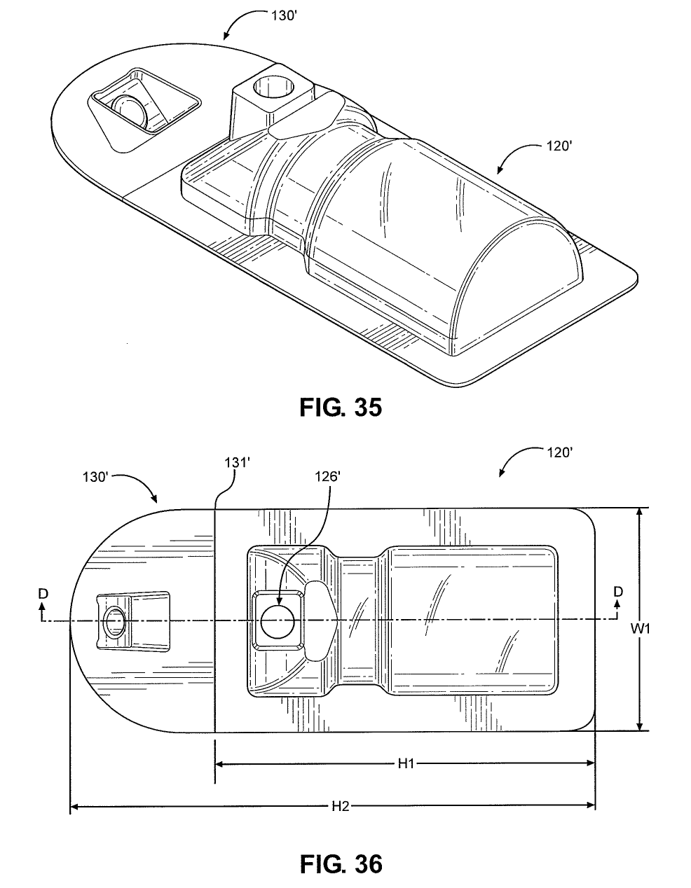

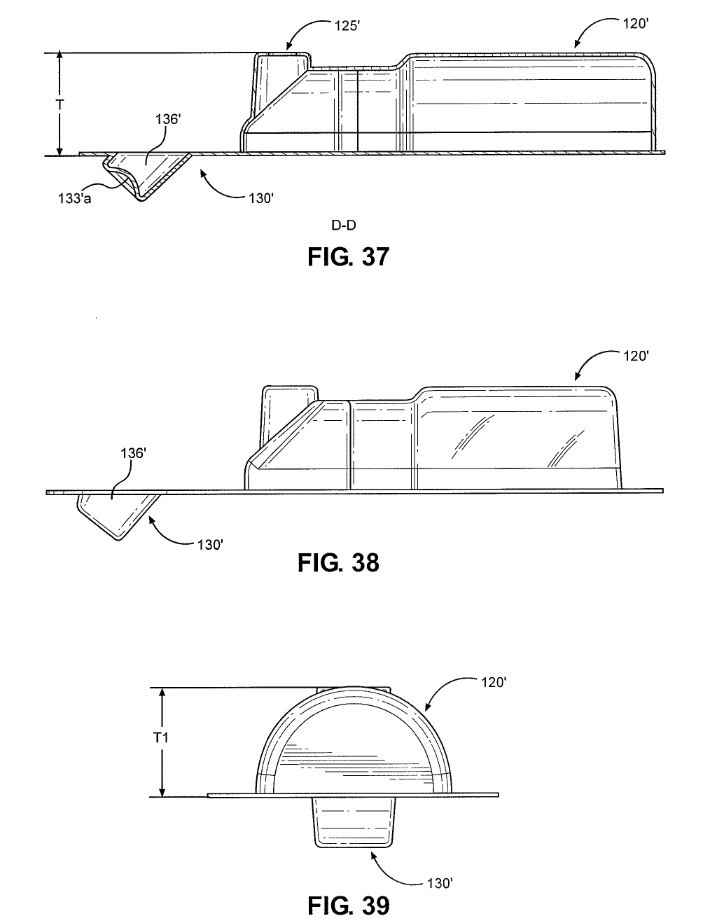

FIGS. 35-39 show a packaging dispenser formed of two components, i.e., the body 120′ and the lid 130′ and without the backing 110′ attached. As should be apparent, the body 120′/130′ can be a one-piece integrally formed member that is shaped from a thin sheet of transparent synthetic resin material. In non-limiting embodiments, the thickness is substantially uniform with the possible exception of the living hinge 131′. The values for the dimensions shown in FIGS. 36 and 37 are, in non-limiting examples, as follows: W1 is about 2.3 inches, H1 is about 3.8 inches, H2 is about 5.3 inches, the diameter of the dispensing opening 126′ is about 0.33 inches, and the thickness T is about 0.86 inches. Like the previous embodiment, the body 120′ has a surrounding flange which secures the body 120′ to the backing 110′. The value for the thickness T1 shown in FIG. 39 is about 0.86.

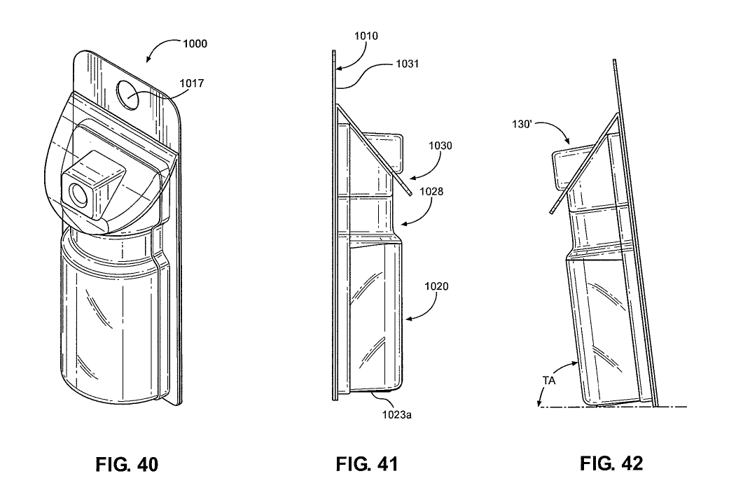

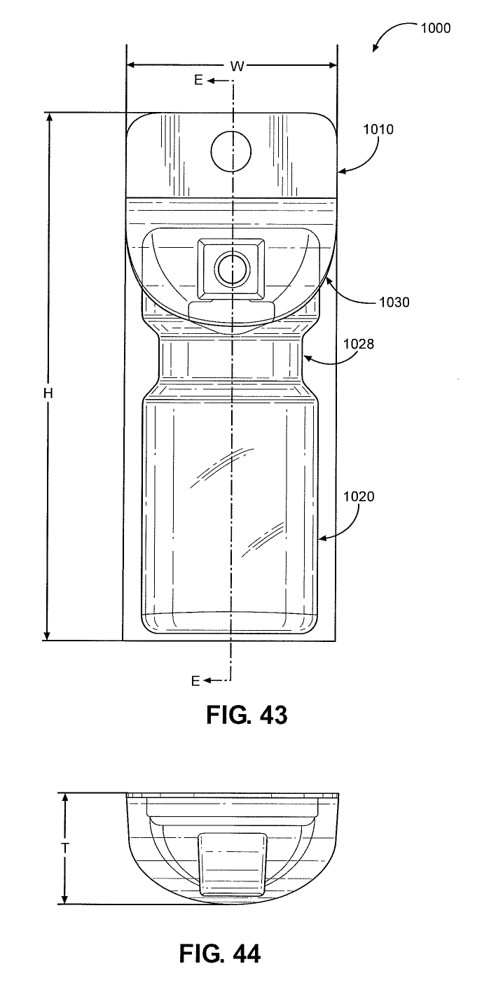

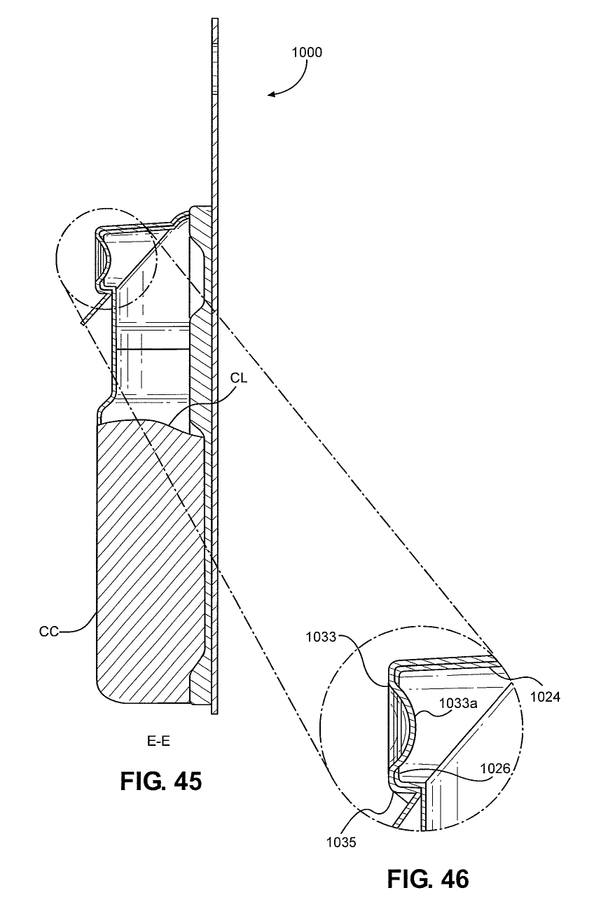

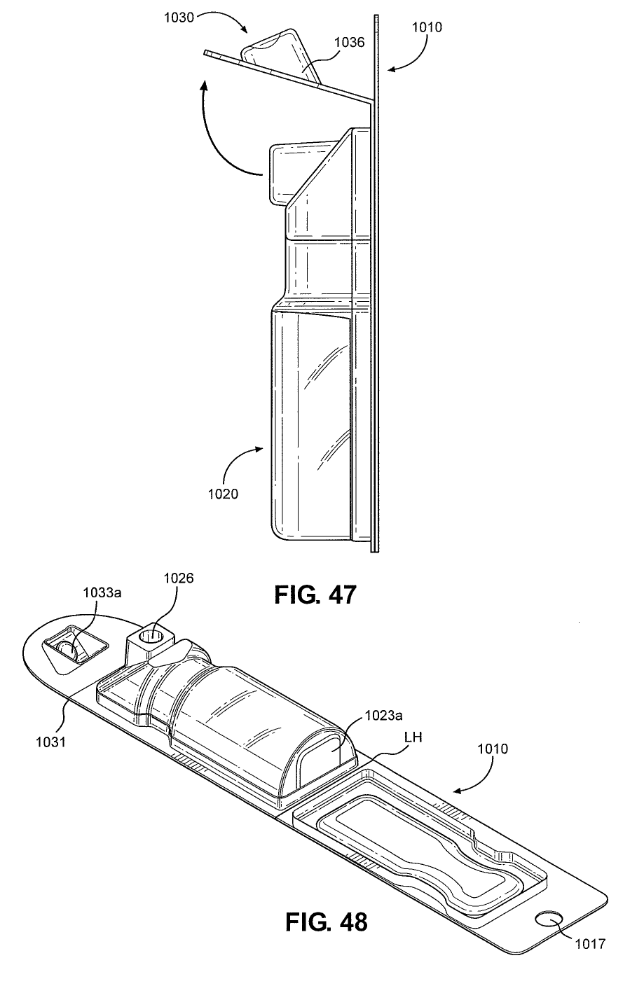

FIGS. 40-47 show a packaging dispenser 1000 that is similar to that shown in FIG. 28 and which is shown contain an amount of dispensable substance (container contents) CC and illustrates how the flip-up lid or cover 1030 can move or pivot to the open position about the living hinge 1031. However, unlike the embodiment of FIG. 28, this embodiment does not use a planar backing such as a paper backing, and instead uses an integrally formed shaped and folded backing 1010. An exemplary fill level CL for the contents CC is shown in FIG. 45, which level CL can be located about the lower end of the neck region 1028. In addition, this embodiment differs from that of FIG. 28 but its use of a foot or standing support projection 1023a. As shown in 42, this foot 1023a can support the package 1000 in a generally upright or slightly tilted position whose tilt angle TA can be about 84 degrees. The package 1000 utilizes a semi-cylindrical (or semi-circular in cross-section) body 1020 whose surrounding flange abuts a similarly shaped flange of the backing 1010. The backing 1010 is coupled to the body 1020 via a living hinge LH. The flip-up lid 1030 is similar to that of FIG. 28 and can be locked or releasably retained in the closed position as shown in FIG. 46—with the retaining recess 1035 of the lid 1030 engaging with a retaining projection of the section 1024. An opening 1017 for hanging the package 1000 is also utilized. The flip-up lid 1030, when in the closed position, closes off the dispenser opening 1026. In addition, this embodiment, like the previous embodiment, employs a dome-shaped dimple 1033a that extends into the dispensing opening 1026 and whose circular region 1033 sealing engages with the circular inner edge of the dispensing opening 1026 (see FIG. 46). The dispensing opening 1026 is arranged on rectangular planar section 1025. In non-limiting embodiments, the volume of the contents CC is about 1.6 cubic inches and the exemplary values for the width W and height H are respectively about 1.9 inches and about 4.6 inches. The value for thickness T is about 0.97 inches.

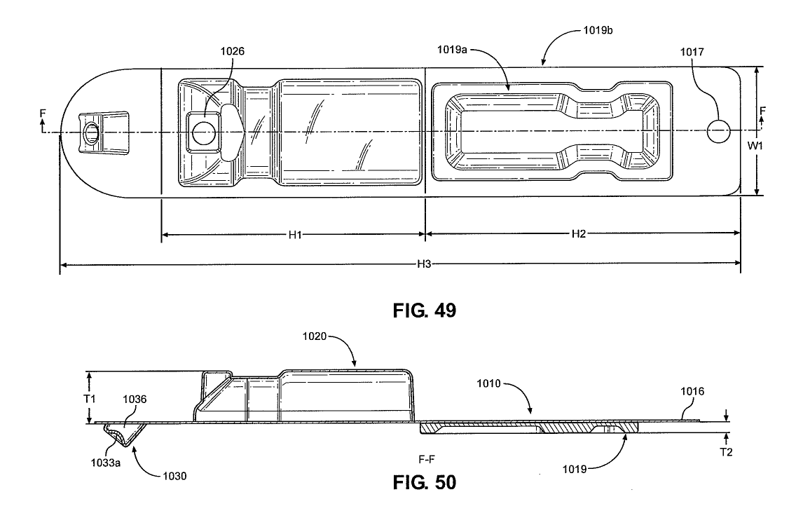

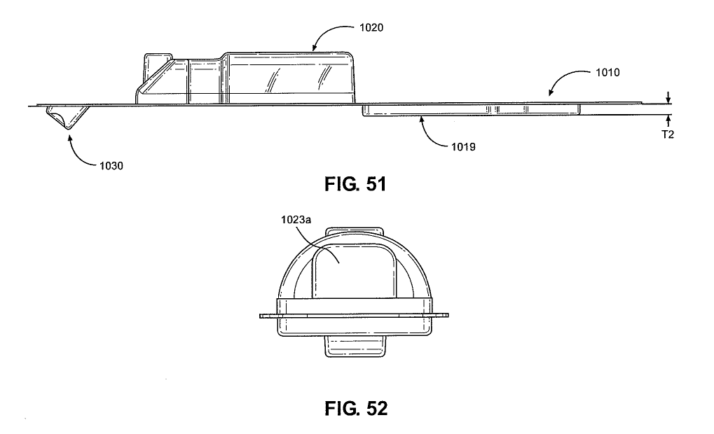

FIGS. 48-52 show a packaging dispenser being formed of a three-component integrally formed member with the body 1020, lid 1030 and backing 1010 connected via living hinges 1031 and LH. A foot 1023a is also utilized. As should be apparent, the body 1020, lid 1030 and backing 1010 can be a one-piece integrally formed member that is shaped from a thin sheet of transparent synthetic resin material. The lid 1030 is attached to the body 1020 via the living hinge 1031 while the backing 1010 is attached to the body 1020 via living hinge LH. The backing 1010 has a shaped protruding portion 1019 that can extend into the back opening of the body 1020 while a surrounding flange of the backing 1010 abuts the similarly shaped flange of the body 1020. In non-limiting embodiments, the thickness of the three-component member is substantially uniform with the possible exception of the living hinges 1031 and LH. The values for the dimensions shown in FIGS. 49-51 are, in non-limiting examples, as follows: W1 is about 1.9 inches, H1 is about 3.9 inches, H2 is about 4.6 inches, H3 is about 9.97 inches, the diameter of the dispensing opening 1026 is about 0.33 inches, the thickness T1 is about 0.85 inches, and the thickness T2 is about 0.18 inches.

FIG. 53 shows how the backing of an embodiment of the type shown in FIG. 40 can be folded about a living hinge to the closed position shown in FIG. 54 and FIG. 54 shows how the flip-up lid of an embodiment of the type shown in FIG. 40 can be folded about a living hinge to the closed position similar to that shown in FIG. 40.

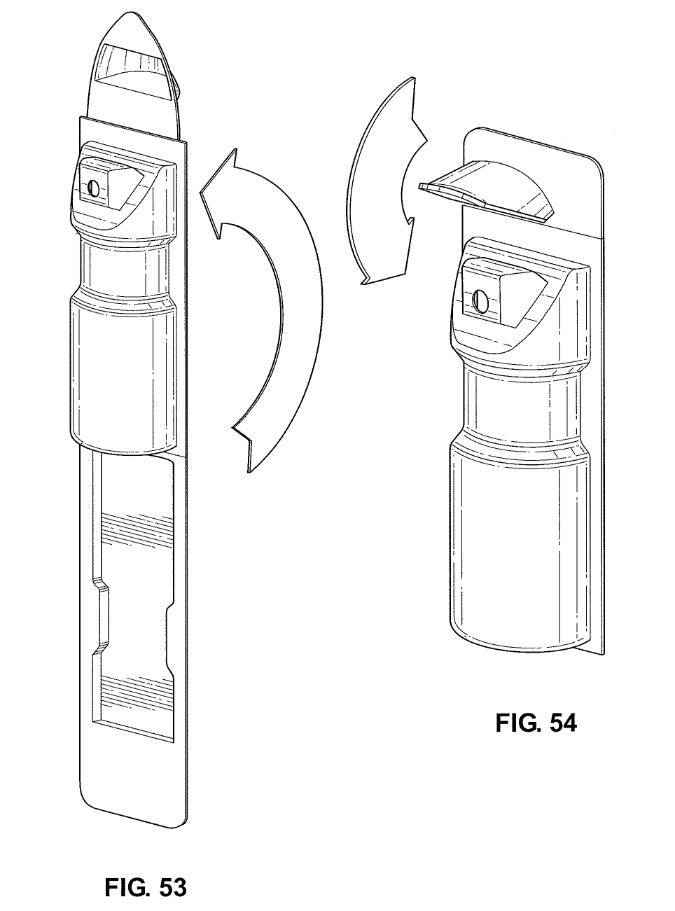

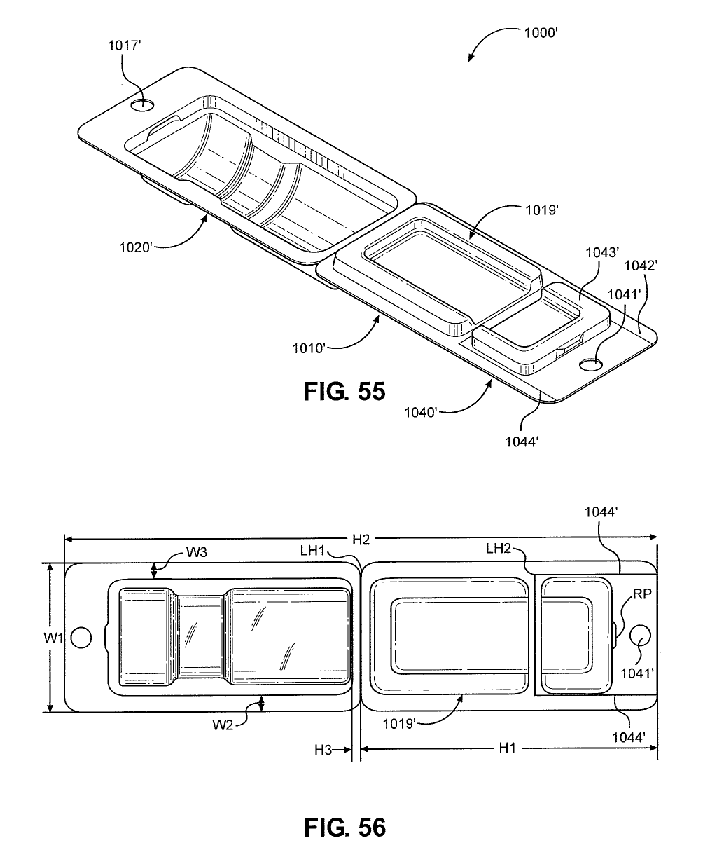

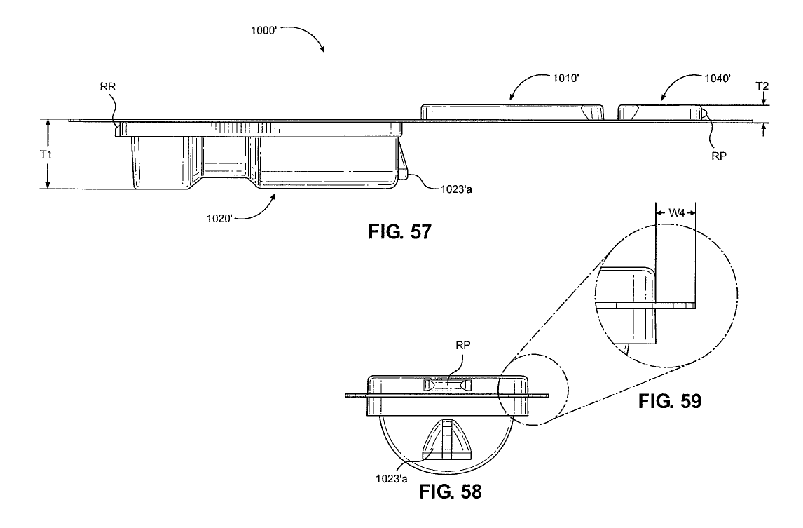

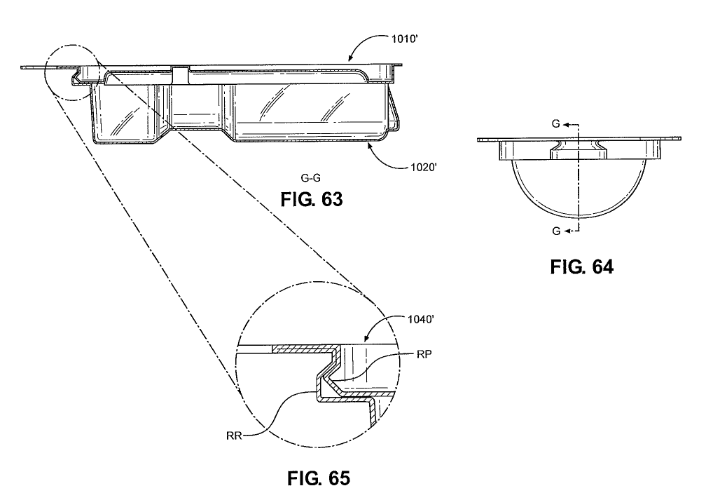

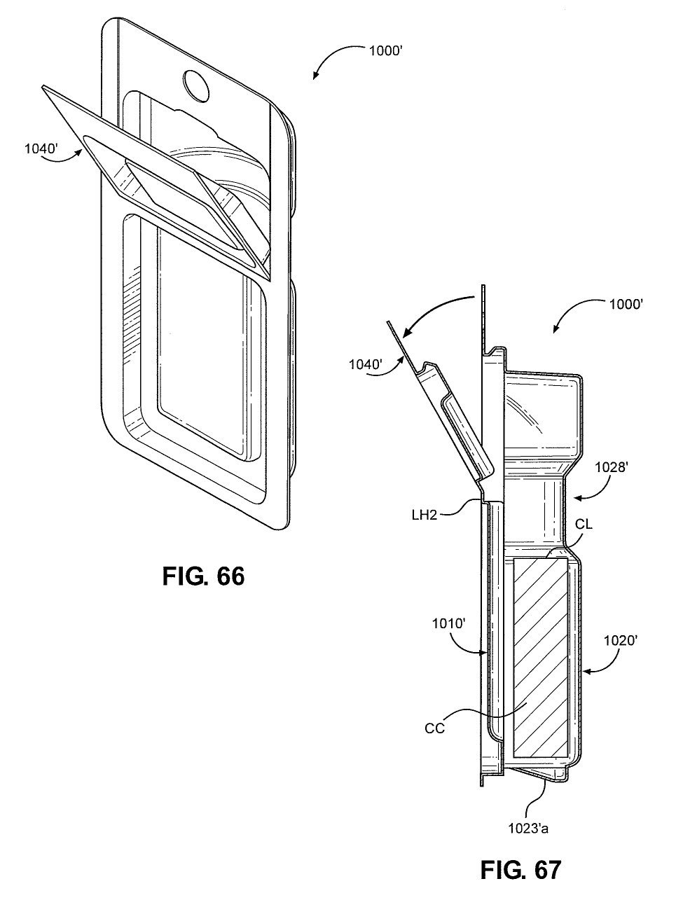

FIGS. 55-67 show another embodiment of a packaging dispenser 1000′. This embodiment is similar to previous embodiments in utilizing an integrally formed three-component member, but replaces the front facing flip-up lid with a rear-facing flip-out lid 1040′. Thus, the three-component member includes a body 1020′, a backing 1010′ and the flip-out lid 1040′. In addition, no front facing dispensing opening is utilized. Instead, as shown in FIGS. 66 and 67, the package 1000′ can dispense the substance CC via the opening that results from moving the flip-out lid 1040′ to the open position. As shown in FIG. 67, the package 1000′ can contain an amount of dispensable substance (container contents) CC. FIG. 67 illustrates how the flip-out lid or cover 1040′ can move or pivot to the open position about the living hinge LH2. In addition, this embodiment uses an integrally formed shaped and folded backing 1010′, attached via the living hinge LH2, to the lid 1040′. An exemplary fill level CL for the contents CC is shown in FIG. 67, which level CL can be located about the lower end of the neck region 1028′. In addition, this embodiment can utilize a foot or standing support projection 1023′a. As shown in FIG. 62, this foot 1023′a can support the package 1000′ in a generally upright or slightly tilted position whose tilt angle TA can be about 85 degrees. The package 1000′ utilizes a semi-cylindrical (or semi-circular in cross-section) body 1020′ whose surrounding flange abuts a similarly shaped flange of the backing 1010′. The backing 1010′ is coupled to the body 1020′ via a living hinge LH1. The flip-out lid 1040′ can be locked or releasably retained in the closed position with the retaining recess RR of the body 1020′ engaging with a retaining projection RP of the lid 1040′ as shown in FIGS. 63 and 65. An opening 1017′ for hanging the package 1000′ is also utilized. The flip-out lid 1040′, when in the closed position, closes off an opening formed in the backing 1010′. In addition, the lid 1040′ includes a shaped projecting portion 1043′ that can extends into the open back of the body 1020′ along with an upper flange section that includes a hanging opening that aligns with the hanging opening 1017′. In non-limiting embodiments, the volume of the contents CC is about 1.0 cubic inch and the exemplary values are as follows: the width W1 is about 2.1, the widths W2 and W3 are about 0.22 inches, the width W4 is about 0.22, the height H1 is about 4.25 inches, the height H2 is about 8.5 inches, and the height H3 is about 0.12 inches. The value for thickness T1 is about 0.81 inches and thickness T2 is about 0.19 inches.

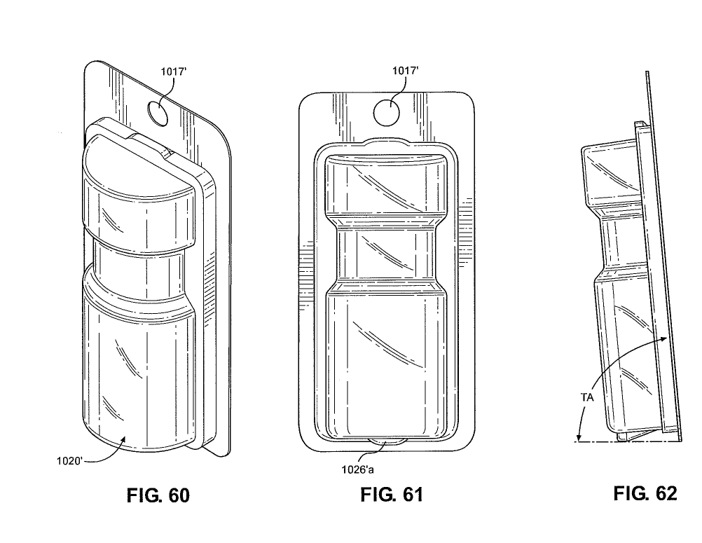

FIGS. 55-59 show a packaging dispenser being formed of a three-component integrally formed member with the body 1020′, lid 1040′ and backing 1010′ connected via living hinges LH1 and LH2. These can be folded into the final assembled state shown in FIG. 60. Preferably, the backing 1010′ is folded into connection with the body 1020′ in a non-releasable manner while the lid 1040′ is only releasably retained to the body 1020′. The body 1020′, lid 1040′ and backing 1010′ can be a one-piece integrally formed member that is shaped from a thin sheet of transparent synthetic resin material. The lid 1040′ has its lower end attached to an upper end of the backing 1010′ via the living hinge LH2 while the backing 1010′ has its lower end attached to a lower end of the body 1020′ via living hinge LH1. The backing 1010′ has a shaped protruding portion 1019′ that can extend into the back opening of the body 1020′ while a surrounding flange of the backing 1010′ abuts the similarly shaped flange of the body 1020′. In non-limiting embodiments, the thickness of the three-component member is substantially uniform with the possible exception of the living hinges LH1 and LH2.

The devices described above can also utilize one or more features disclosed in the prior art documents expressly incorporated by reference herein. Furthermore, one or more of the various parts of the device can preferably be made as one-piece structures by e.g., injection molding, when doing so reduces costs of manufacture. Non-limiting materials for all of the parts include synthetic resins such as those approved for food product packaging. Furthermore, the invention also contemplates that any or all disclosed features of one embodiment may be used on other disclosed embodiments, to the extent such modifications function for their intended purpose.

At least because the invention is disclosed herein in a manner that enables one to make and use it, by virtue of the disclosure of particular exemplary embodiments of the invention, the invention can be practiced in the absence of any additional element or additional structure that is not specifically disclosed herein.

It is noted that the foregoing examples have been provided merely for the purpose of explanation and are in no way to be construed as limiting of the present invention. While the present invention has been described with reference to an exemplary embodiment, it is understood that the words which have been used herein are words of description and illustration, rather than words of limitation. Changes may be made, within the purview of the appended claims, as presently stated and as amended, without departing from the scope and spirit of the present invention in its aspects. Although the present invention has been described herein with reference to particular means, materials and embodiments, the present invention is not intended to be limited to the particulars disclosed herein; rather, the present invention extends to all functionally equivalent structures, methods and uses, such as are within the scope of the appended claims.

What is claimed:

1. A dispenser package comprising:
a backing;
a dispenser body coupled to the backing; and
a flip-up or flip-out cover movable between a covering position and an open position.

2. The dispenser package of claim 1, wherein the backing is non-transparent.

3. The dispenser package of claim 1, wherein the backing is rectangular.

4. The dispenser package of claim 1, wherein the backing comprises an opening arranged adjacent at an upper end.

5. The dispenser package of claim 1, wherein the container body is transparent or translucent.

6. The dispenser package of claim 1, wherein the container body is semi-cylindrical.

7. The dispenser package of claim 1, wherein the container body comprises a semi-cylindrical main section.

8. The dispenser package of claim 1, wherein the container body comprises a dispensing opening arranged adjacent at an upper end.

9. The dispenser package of claim 8, wherein the dispenser opening arranged on a generally planar surface.

10. The dispenser package of claim 1, wherein the flip-up cover is at6 least one of:
pivotally mounted; and
connected to the dispenser body via a living hinge.

11. The dispenser package of claim 10, wherein the flip-up cover a finger grippable portion and a covering portion, said covering portion having a three-dimensional shape that mimics a three-dimensional shape of an upper portion of the container body.

12. The dispenser package of claim 1, wherein the dispenser package is a food or spice dispenser package.

13. The dispenser package of claim 1, wherein the flip-up cover comprises a retaining mechanism that releasably engages with a retaining mechanism of the dispenser body.

14. A hanging food particulate dispenser package comprising:
a rectangular planar backing;
a dispenser body secured to the backing;
a dispensing opening arranged at an upper area of the dispenser body; and
one of:
a pivotally mounted flip-up cover movable between a releasably locked or retained position overlying the dispensing opening and an open position allowing a food particulate to be dispensed from the dispensing opening; or
a transparent synthetic resin pivotally mounted flip-up cover movable between a releasably locked or retained position overlying the dispensing opening and an open position allowing spice to be dispensed from the dispensing opening.

15. A hanging dispenser package comprising:
a rectangular planar backing;
a transparent synthetic resin dispenser body secured to the backing;
a dispensing opening arranged at an upper area of the dispenser body;
a tamper evident label removably attached to a surface of the dispenser body adjacent the dispensing opening;
a label attached to a main portion of the dispenser body and containing indicia identifying the spice disposed inside the spice dispenser; and
a transparent synthetic resin pivotally mounted flip-up or flip-out cover movable between a releasably locked or retained position and an open position allowing spice to be dispensed from the dispensing opening.

16. A method of making the package of claim 15, the method comprising:
forming a dispenser body; and
attaching the dispenser body to a backing.

17. A method of making the package of claim 1, the method comprising:
forming a dispenser body with an integral flip-up cover; and
attaching the dispenser body to a backing.

18. A spice package configured to store and dispense a spice, comprising:
an opening for supporting the dispenser package in a hanging position;
a backing;
a semi-cylindrical or semi-circular dispenser body coupled to the backing; and
a cover or lid movable between a closed position and an open position.

19. The spice dispenser package of claim 18, wherein the cover or lid is a front-facing flip-up cover or lid.

20. The spice dispenser package of claim 18, wherein the cover or lid is a rear-facing flip-out cover or lid.

21. The spice dispenser package of claim 18, further comprising a foot arranged on the body that is configured to support the spice dispenser in either a generally upright position or slightly tilted upright position.
